(19) United States
(12) Patent Application Publication
(10) Pub. No.: US 2013/0029078 A1
(43) Pub. Date: Jan. 31, 2013

(54) TEMPORARY DECORATION FOR FABRIC

(71) Applicants: Brandon Douglas GADDIS, Cincinnati, OH (US); Nicolas Remy Denis Joseph Pochart, Cincinnati, OH (US); Heidi Hsieh, Forest Park, OH (US); Alvin Tsung So, Beijing City (CN); Lloyd Keith Stephenson, JR., Burlington, KY (US)

(72) Inventors: Brandon Douglas GADDIS, Cincinnati, OH (US); Nicolas Remy Denis Joseph Pochart, Cincinnati, OH (US); Heidi Hsieh, Forest Park, OH (US); Alvin Tsung So, Beijing City (CN); Lloyd Keith Stephenson, JR., Burlington, KY (US)

(21) Appl. No.: 13/557,533

(22) Filed: Jul. 25, 2012

Related U.S. Application Data
(63) Continuation-in-part of application No. 13/189,904, filed on Jul. 25, 2011.

(51) Int. Cl. B44C 1/165; B32B 38/10; B32B 38/08

(52) U.S. Cl. 428/41.8; 156/278; 156/250; 156/249; 156/703; 156/750; 428/352; 428/354; 428/195.1

(57) ABSTRACT

A temporary decoration which can be applied by a user to fabrics such as articles of clothing. The temporary decoration may be easily applied to the fabric in a quick and efficient manner without the use of heat or a solvent. Once applied to fabric, the temporary decoration is durable and does not undesirably crack. Additionally, the temporary decoration is easily removable. The present invention also relates to a method for making a temporary decoration.

### CROSS REFERENCE TO RELATED APPLICATION

This application is a Continuation-In-Part of U.S. application Ser. No. 13/189,904, filed Jul. 25, 2011.

### FIELD OF THE INVENTION

The present invention relates to a temporary decoration for fabric which can be easily applied by a user to the fabric without the use of heat or a solvent.

### BACKGROUND OF THE INVENTION

It is desirable to provide a temporary decoration which can be easily applied by a user to fabric substrates such as articles of clothing. There are several difficulties which can be encountered with temporary decorations for fabric especially those temporary decorations which are applied to denim jeans. For instance, the temporary decoration may not be easy for the user to apply to the fabric. It may be difficult for the user to determine when enough pressure has been applied to effect transfer of the decoration to the fabric. Additionally, once applied to the fabric, difficulties can be encountered with the longevity and quality of the temporary decoration in-wear. For instance, if the temporary decoration is not durable once it is applied to the fabric it can show signs of premature wear such as cracking and rub-off from the fabric which can undesirably alter the look of the temporary decoration. This problem can be even more evident with fabrics such as denim jeans which tend to be subjected to more in-wear movement and direct contact with a wide variety of surfaces including those which may be traditionally considered rougher surfaces non-limiting examples of which may include rough wooden surfaces (e.g.; wooden bleachers), asphalt, concrete, and the like. Therefore it is desirable that the temporary decoration exhibit good wear resistance including flexibility and resistance to excessive or unwanted cracking so as not to exhibit premature wear.

Another concern associated with temporary decorations is once applied to the fabric the temporary decoration may have an inferior quality look and feel to it. Hence, it is desirable that once applied to the fabric the temporary decoration have a professional look and feel as if the temporary decoration was included as an original part of the fabric during the original fabric manufacturing process.

An additional concern associated with temporary decorations is the difficulty a user may have removing the temporary decoration from the fabric. Hence, it is desirable that when a user is ready to remove the temporary decoration the decoration be easily removable without damage to the fabric.

The current invention addresses these concerns by providing a temporary decoration that is easy to apply to fabric, provides a visual signal to the user that the decoration has been 29

completely transferred, is durable, meaning it does not undesirably crack, provides a professional look and feel and is easy to remove from the fabric.

This and other features, aspects, advantages, and variations of the present invention will become evident to those skilled in the art from a reading of the present disclosure with the appended claims and are covered within the scope of the claims.

### SUMMARY OF THE INVENTION

In one aspect, the present invention relates to a temporary decoration for fabric. A temporary decoration for application to fabric may comprise

a) a backing sheet;

b) a colorant wherein the colorant is an ink, a pigment, a dye, or a combination thereof;

c) an adhesive layer comprising a pressure sensitive adhesive; and

d) a release agent, wherein said release agent is included as a separate release layer, a part of the colorant, and combinations thereof;

e) optionally a protective layer made of polyurethane;

f) optionally a release sheet; wherein the temporary decoration is applied without the need for heat or a solvent;

In another aspect of the invention, a method is provided for making a temporary decoration for fabric wherein the method comprises the steps of:

a) providing a screen;

b) placing a backing sheet under the screen;

c) applying a release agent to the screen such that the release agent contacts the backing sheet;

d) applying a colorant to the screen such that the colorant contacts the release layer; and

e) applying a pressure sensitive adhesive to the screen such that the pressure sensitive adhesive contacts the colorant.

In yet another aspect of the invention a method is provided for making a temporary decoration for fabric wherein the method comprises the steps of:

a) providing a backing sheet;

b) applying a release agent to the top of the backing sheet;

c) utilizing an applicator rod to apply the release agent in the y-axis direction of the backing sheet so as to form a layer of uniform thickness of the release agent on the backing sheet;

d) drying the backing with the release agent applied thereto;

e) applying a polyurethane protective layer to the top of the release agent layer;

f) utilizing an applicator rod to apply the protective layer in the y-axis direction of the backing sheet so as to form a layer of uniform thickness of the protective layer on the release layer;

g) drying the backing with the protective layer applied thereto;

g) applying a colorant to the top of the protective layer;

h) utilizing the applicator rod to apply the colorant in the y-axis direction of the backing sheet so as to form a layer of uniform thickness of the colorant on the protective layer;

i) drying the backing with the colorant applied thereto;

h) applying a pressure sensitive adhesive to the top of the colorant;

i) utilizing the applicator rod to apply the pressure sensitive adhesive in the y-axis direction of the backing sheet so as to form a layer of uniform thickness of the pressure sensitive adhesive on the colorant layer;

j) drying the backing with the pressure sensitive adhesive applied thereto;

k) applying a release sheet to the backing sheet; and

l) using a laser to cut into the shape of a desired pattern.

In a further aspect of the present invention, a method is provided for a user to apply a temporary decoration to fabric. The method comprises the steps of:

a) providing a temporary decoration comprising a backing sheet which includes a release layer, a colorant comprising a design, an adhesive layer, and a release sheet;

b) removing the release sheet;

c) applying the temporary decoration to a fabric by contacting the adhesive layer of the temporary decoration to the fabric; and

d) rubbing a finger nail, a rubbing implement, or a combination thereof across the temporary decoration so as to transfer the design-containing portion of the temporary decoration to the fabric.

In further aspects of the present invention the temporary decoration comprises a design-containing portion and a backing portion, wherein the force required to separate the design-containing portion of the temporary decoration from the backing portion of the temporary decoration is from about 0.01 Newtons to about 0.33 Newtons as measured by the 90° Peel Method. The temporary decoration also comprises a design-containing portion having a thickness from about 35 microns to about 100 microns as measured by the Caliper Method. Additionally, the temporary decoration comprises a design-containing portion which exhibits no cracking using a cylinder having less than or equal to a 0.75 inch diameter as measured by the Mandrel Bend Test. Furthermore, the temporary decoration comprises a design-containing portion applied to fabric wherein the differential between the stiffness of the fabric with the design-containing portion applied thereto and the stiffness of the fabric without the design-containing portion applied thereto is from about 0 grams to about 90 grams as measured by the Stiffness Measurement-Blade Slot Method.

In yet another aspect of the present invention, a method is provided for removing the temporary decoration from fabric by contacting the design-containing portion of the temporary decoration with water. In still another aspect the temporary decoration may be removed from fabric by contacting the design-containing portion of the temporary decoration with water and then contacting the design-containing portion with a removal implement. The removal implement may be a pad.

In still another aspect of the present invention a temporary decoration kit is provided wherein the kit comprises a temporary decoration which includes a design-containing portion for application to fabric and a removal implement for removing the design-containing portion from the fabric.

### DETAILED DESCRIPTION OF THE INVENTION

Reference will now be made in detail to various embodiments of the present invention, examples of which are illustrated in the accompanying drawings wherein like numerals indicate the same elements throughout the views. All percentages, ratios and proportions herein are on a weight basis unless otherwise indicated.

Except as otherwise noted, all amounts including quantities, percentages, portions, and proportions, are understood to be modified by the word “about”, and amounts are not intended to indicate significant digits.

Except as otherwise noted, the articles “a”, “an”, and “the” mean “one or more”.

As used herein, “comprising” means that other steps and other ingredients which do not affect the end result can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein.

As used herein, “temporary” refers to something which is not intended to be permanent.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Temporary Decoration

The temporary decoration of the present invention may be applied by a user to fabric including but not limited to articles of clothing. One non-limiting example of a fabric that the temporary decoration may be applied to is cotton fabric and blends thereof such as denim. The temporary decoration of the present invention may comprise a colorant, non-limiting examples of which include inks, pigments, and dyes, which is applied to a backing sheet. The colorant may be applied to the backing sheet in the form of a decorative pattern. In one non-limiting embodiment, a release layer comprising a release agent may be applied to a backing sheet and a colorant applied thereto. In yet another non-limiting embodiment, the release agent may be embodied as part of the colorant layer and a separate release layer may not be required. Instead a colorant such as an ink, additionally containing a release agent, is applied directly to the backing sheet. An adhesive, a non-limiting example of which is a pressure sensitive adhesive, may be applied after application of the colorant and/or the release agent to the backing sheet. Optionally, a release sheet is then applied after the release agent, colorant and adhesive, have been applied to the backing sheet.

In another non-limiting embodiment, the temporary decoration comprises a backing sheet to which a colorant such as an ink is applied. An adhesive is then applied to the ink. Optionally, a release sheet is then applied after the ink and adhesive have been applied.

In yet another non-limiting embodiment, the temporary decoration comprises a backing sheet. A release layer is applied to the backing sheet. A protective layer is then applied after the release layer wherein this protective layer may provide structure such as elasticity to the temporary decoration which can help provide resistance to cracking. An ink is then applied to the protective layer and an adhesive is then applied after the ink. A release sheet is then applied. This composite is then laser cut to the desired decorative pattern so as to form the temporary decoration. In a further embodiment, the temporary decoration comprises a backing sheet. A mixture of an ink and release agent are then applied to the backing sheet. A pressure sensitive adhesive is then applied after which a release sheet is applied.

It is desirable that the temporary decoration of the present invention be durable. It is also desirable that the temporary decoration exhibit good wear resistance including flexibility and resistance to cracking so as not to exhibit premature wear. The resistance of a material to cracking may be measured via the Mandrel Bend test (ASTM D522-93A—Standard Test Methods for Mandrel Bend Test of Attached Organic Coatings, Test Method B—Cylindrical Mandrel Test). It is desirable that the temporary decoration of the present invention exhibit no cracking using a cylinder having less than a 1 inch diameter, or using a cylinder having a ¾ inch diameter, or using a cylinder having a ½ inch diameter, or using a cylinder having a ⅜ inch diameter, or using a cylinder having a ¼ inch diameter, or using a cylinder having a ⅛ inch diameter when tested in accordance with the Mandrel Bend Test described in the Test Methods section of this patent application. It is also desirable that the temporary decoration of the present invention be easy to apply to the fabric. The 90° Peel Method may be used to measure the force needed to remove/separate the graphic-containing portion (also referred to as the design-containing portion) of the temporary decoration from the backing portion of the temporary decoration. It is desirable that the force required to separate the graphic-containing portion of the temporary decoration from the backing portion of the temporary decoration be from about 0.01 Newtons to about 0.33 Newtons or from about 0.05 Newtons to about 0.10 Newtons.

In another embodiment of the invention there is provided a visual signal to the user that the decoration has successfully separated from the backing portion and transferred to the fabric. The visual signal may include a lightening of the colored portion of the decoration, a change in intensity of the colored portion of the design when viewed from through the backing sheet etc. Decorations according to this aspect of the invention will typically provide a measurement of less than or equal to about 0.33 Newtons in the 90° Peel Method as described herein.

It is further desirable that the temporary decoration once applied to the fabric have a professional look and feel as if the temporary decoration was included as an original part of the fabric during the original fabric manufacturing process. It is also desirable that the graphic containing portion of the temporary decoration have a thickness from about 35 microns to about 100 microns. It is additionally desirable that the temporary decoration of the present invention be durable.

Professional looking and/or feeling decorations are related to the stiffness of the temporary decoration after application to fabric. It is believed that the lower the stiffness, the more integrated into the fabric the temporary decoration will appear. Stiffness of the temporary decoration after application to the fabric is measured by considering the differential or delta between the stiffness of the fabric alone and the total of the stiffness of the graphic containing portion of the temporary decoration together with the fabric that it is applied to. Low stiffness deltas may be provided either by providing a decoration that stretches with the denim or a decoration that forms many small cracks upon stretching. In either case, the denim is allowed to act as it would without the presence of a temporary decoration. Stiffness may be calculated via the below equation:

Stiffness of the graphic containing portion of the temporary decoration=(total stiffness of the fabric and the graphic containing portion of the temporary decoration applied thereto)−stiffness of the fabric only.

Therefore, it is desirable that the differential (or delta) in stiffness between the fabric alone and the total stiffness of the graphic containing portion of the temporary decoration together with the fabric that it is applied to be a differential of from about 0 grams to about 90 grams, from about 10 grams to about 85 grams, or from about 20 grams to about 80 grams.

### I. Components of the Temporary Decoration

### A. Backing Sheet

The backing sheet of the present invention may comprise high density polyethylene (“HDPE”). One suitable HDPE has a thickness of 7 mils (178 microns) and is available from Central Chemical & Service Corporation of Carol Stream, Ill. A non-limiting list of other suitable materials which may be used as the backing sheet of the present invention include polymeric films including but not limited to polyethylene, polystyrene, polypropylene, or the like. A variety of different film thicknesses may be used but preferably from about 2 mils up to about 15 mils.

### B. Release Agent

When present, the release agent may be colored, clear, or a combination thereof. The release agent may comprise polyurethane. When used, the polyurethane may be formed by the reaction product of a hexanedioic acid polymer with a catalyst. Polymeric mixtures of polyols, carboxylic acids, or polyesters which react with diisocyanates to form polyurethanes are also suitable. One non-limiting example of a suitable catalyst is toluene 2,6-diisocyanate though other diisocyanates may also be used as catalysts.

One non-limiting example of a clear release agent comprises a mixture of about 60% of DA170 (Hexanedioic acid polymer) available from Nazdar Company of Shawnee, Kans., with about 40% of DA176 (toluene 2,6-diisocyanate) also available from Nazdar Company. One non-limiting example of a colored release agent comprises a mixture of about 77% DALF104 (Hexanedioic acid polymer with colorant) available from Nazdar Company with about 19% of DA176 (toluene 2,6-diisocyanate) and if desired about 4% RE188 thinner also available from the Nazdar Company. Alternatively, a silicone containing release agent may be included. One suitable silicone containing release agent is Transfer Lacquer available from Central Chemical & Service Corporation. The release agent may be included as a separate release layer or may be included as a part of the colorant as described below.

While not wishing to be bound by theory, it is believed that a lower ratio of hexanedioic acid to toluene-2,6-diisocyanate, for example 75:1 to 85:1 leads to increased cross-linking leading to increased rigidity and less elasticity. These characteristics may lead to easier release from the backing sheet (due to less interaction with the backing) and higher stiffness values on denim vs denim only.

As the ratio of hexanedioic acid:toluene-2,6-diisocyanate increase, for example 115:1 to 130:1, the cross-linking is decreased, leading to lower rigidity and stiffness. This leads to more elastic temporary decorations which have more interaction with the backing but increased elasticity which leads to lower stiffness deltas on denim.

Therefore, depending upon the elasticity and rigidity characteristics that are desired an appropriate ratio of hexanedioic acid to toluene-2,6-diisocyanate when formulating a release agent is from about 70:1 to about 135:1.

Another suitable release agent is the 9800 series of UV clears commercially available from 3M Corporation.

### C. Colorant

Though a colorant may be part of the release layer as described above when a release layer is included, the colorant may also be separately applied to the backing either in addition to or instead of utilizing a release layer. Non-limiting examples of suitable colorants include inks, pigments, and dyes. The inks may be water-based, solvent-based, UV curable or a combination thereof. For instance, in one non-limiting example, a screen printing process may be used to directly apply a desired pattern to a backing sheet. A non-limiting example of a suitable ink for this purpose is a water-based ink such as the SYMPHONY line of inks available from Sun Chemical Corporation of Carlstadt, N.J. Another non-limiting example of one such ink is DALF104 (Hexanedioic acid polymer with colorant) available from Nazdar Company of Shawnee, Kans. While not wishing to be bound by theory, when the colorant and the release agent are provided as a single layer the ratio of hexanedioic acid to toluene-2,6-diisocyanate, may be higher than when a clear release agent is separately used. This results in a colorant layer that is more elastic. The ratio of hexanedioic acid to toluene-2,6-diisocyanate in this case may be for example from about 75:1 to about 135:1, when the layers are provided separately the ratios may be from about 75:1 to about 135:1 for the clear layer and about 200:1 to about 225:1 for the colored layer.

The FIDELITY line of inks available from Sun Chemical Corporation of Carlstadt, N.J. also represents a non-limiting example of suitable ink when utilizing a rod coating printing process. When a rod coating printing process is used it may be desirable to first apply a transfer lacquer to the backing so as to provide a release agent layer on the backing. One non-limiting example of a suitable transfer lacquer is OPTICOLOR® Transfer Lacquer available from Central Chemical & Service Corporation of Carol Stream, Ill. After application of the transfer lacquer to the backing, it may be desirable to then apply a protective layer such as PERMA-WET Gloss Coating available from The Monster Makers, Incorporated of Lakewood, Ohio. The ink would then be applied after the transfer lacquer and after the gloss coating are applied to the backing. While not wishing to be limited by theory, it is believed that the PERMA-WET provides a protective layer which provides strength and elasticity to the ink and release layers which may otherwise potentially be brittle.

Additional inks that are also suitable are available from Colorcon Company, specifically the NT28 system of no-Tox Paper/Posterboard Inks.

### D. Adhesive Layer

The adhesive layer of the present invention may comprise a pressure sensitive adhesive. The pressure sensitive adhesive may either be aqueous or solvent based. Suitable pressure sensitive adhesives are typically acrylic polymer based. These acrylic polymers contain carboxylic acid groups. While not wishing to be limited by theory, it is believed that these carboxylic acid groups may bond via hydrogen bonding with the hydroxyl groups on the cellulosic surface of the fabric to which a temporary decoration is applied to. When water is added to remove the temporary decoration from the surface of the fabric it is believed that the water disrupts the hydrogen bonds formed causing release of the temporary decoration from the fabric. By scratching the fabric surface for instance using a fingernail or other tool, the removal process can be sped up by allowing more water to reach the interface of the fabric with the adhesive of the temporary decoration. The pressure sensitive adhesive of the present invention may have a Loop Tack test value (ASTM Test Method D6195-03 entitled “Standard Test Methods for Loop Tack”) of greater than 0.5 psi or greater than 0.5 psi to about 10 psi. Non-limiting examples of suitable pressure sensitive adhesives include SP7533 available from 3M of St. Paul, Minn., KIWOPRINT L 4000 available from KIWO Inc. of Seabrook, Tex., ROBOND PS-8915 available from the Rohm and Haas Company of Philadelphia, Pa., and ACRONAL A240 available from BASF Corporation of Florham Park, N.J., and AM-CO45-2, screen printable Pressure sensitive acrylic emulsion commercially available from Cox Sales Company, Salem Va.

### E. Release Sheet

When used as part of the present invention non-limiting examples of suitable release sheets include siliconized paper, parchment paper, and wax paper. One non-limiting example of a suitable silicone coated release sheet is FASSON RAPID ROLL 2.5 Pt. SC Easy Release Liner Spec#53076 available from Avery Dennison of Mentor, Ohio. Other non-limiting examples of suitable release sheets include Parchment Paper and CUT-RITE wax paper both available from Reynolds Consumer Products Company of Richmond, Va.

### Methods of Making the Temporary Decoration

The temporary decoration of the present invention may be made in any number of ways non-limiting examples of which including a screen printing process and a rod coating process each of which is described in more detail below.

### A. Screen Printing Process

The temporary decoration of the present invention may be made by a screen printing process. In one non-limiting example of a screen printing process the temporary decoration may be made as follows:

a) Utilize a screen, one non-limiting example of which is a 158 mesh size screen that includes a pattern or desired indicia.
b) Lay a piece of backing underneath the screen and line up the backing with the registration marks on the screen.
c) Bring the screen down over the backing and apply a release agent to the top of the screen in the non-patterned region of the screen. Using a squeegee apply the release agent through the screen to the backing in one stroke of the squeegee so as to form a layer of uniform thickness.
d) Raise the screen and remove the backing with the release agent layer applied thereto and place it onto a drying rack to cure for at least twenty-four hours.
e) Take the backing from the drying rack, lay it down underneath the screen and line up the registration marks.
f) Bring the screen down over the backing and apply an ink to the top of the screen in the non-patterned region of the screen. Using a squeegee apply the ink through the screen to the backing in one stroke of the squeegee.
g) Raise the screen and remove the backing which now has the release layer and an ink applied thereto and place it onto a drying rack to cure for twenty-four hours.
Note that steps e), f), and g) may be repeated as many times as desired for each different color of ink to be applied.
h) Take the backing from the drying rack, lay it down underneath the screen and line up the backing with the registration marks on the screen.
i) Take a different screen, one non-limiting example of which is a 60 mesh screen that includes a pattern or desired indicia and bring the screen down over the backing to which the release agent layer and ink have already been applied thereto and apply adhesive to the top of the screen in the non-patterned region of the screen. Using a squeegee apply the adhesive through the screen to the backing with one stroke of the squeegee.
j) Raise the screen and remove the backing which now has the release layer, ink, and pressure sensitive adhesive applied thereto and place it onto a drying rack to cure for twelve hours.
k) Remove the backing with the subsequent layers of release agent, ink, and adhesive from the drying rack and apply a release sheet.

In another non-limiting example of a screen printing process the temporary decoration may be made as follows:

a) Utilize a screen, one non-limiting example of which is a 158 mesh size screen that includes a pattern or desired indicia.
b) Lay a piece of backing underneath the screen and line up the backing with the registration marks on the screen.
c) Bring the screen down over the backing and apply an ink to the top of the screen in the non-patterned region of the screen. Using a squeegee apply the ink through the screen to the backing in one stroke of the squeegee.
d) Raise the screen and remove the backing which now has the ink applied thereto and place it onto a drying rack to cure for at least twenty-four hours.
Note that steps b), c), and d) may be repeated as many times as desired for each different color of ink to be applied.
e) Take the backing from the drying rack, lay it down underneath the screen and line up the backing with the registration marks on the screen.
f) Take a different screen, one non-limiting example of which is a 60 mesh screen that includes a pattern or desired indicia and bring the screen down over Lay a piece of backing and apply adhesive to the top of the screen in the non-patterned region of the screen. Using a squeegee apply the adhesive through the screen to the backing with one stroke of the squeegee.
g) Raise the screen and remove the backing which now has the ink and pressure sensitive adhesive applied thereto and place it onto a drying rack to cure for twelve hours.
h) Remove the backing with the subsequent layers of ink and adhesive from the drying rack and apply a release sheet.

In another non-limiting example of a screen printing process the temporary decoration may be made as follows:

a) Utilize a screen, one non-limiting example of which is a 110 mesh size screen that includes a pattern or desired indicia.

b) Lay a piece of backing underneath the screen and line up the backing with the registration marks on the screen.

c) Bring the screen down over the backing and apply a clear release agent, one non-limiting example of which is 7227 MIXING/OVERPRINT CLEAR available from the Nazdar Company of Shawnee, Kans., to the top of the screen in the non-patterned region of the screen. Using a squeegee apply the release agent through the screen to the backing in one stroke of the squeegee so as to form a layer of uniform thickness.

d) Raise the screen and remove the backing with the MIXING/OVERPRINT CLEAR applied thereto and place it onto a drying rack to cure for one hour.

e) Take the backing from the drying rack, lay it down underneath the screen and line up the registration marks.

f) Bring the screen down over the backing and apply an ink such as a SYMPHONY ink to the top of the screen in the non-patterned region of the screen. Using a squeegee apply the ink through the screen to the backing in one stroke of the squeegee.

g) Raise the screen and remove the backing which now has the release layer and an ink applied thereto and place it onto a drying rack to cure for one hour.

Note that steps e), f), and g) may be repeated as many times as desired for each different color of ink to be applied. h) Take the backing from the drying rack, lay it down underneath the screen and line up the backing with the registration marks on the screen

i) Using the same 110 mesh screen bring the screen down over the backing to which the release agent and ink have already been applied thereto and apply adhesive to the top of the screen in the non-patterned region of the screen. Non-limiting examples of suitable adhesives for this purpose include ROBOND PS-8915 adhesive, KIWOPRINT 4000, and ACRONAL A240. Using a squeegee apply the adhesive through the screen to the backing with one stroke of the squeegee so as to form a layer of uniform thickness.
j) Raise the screen and remove the backing which now has the release agent, ink, and pressure sensitive adhesive applied thereto and place it onto a drying rack to cure for twelve hours.
k) Remove the backing with the subsequent layers of release agent, ink, and adhesive from the drying rack and apply a release sheet.

### B. Rod Coating Process

The temporary decoration of the present invention may be made by a rod coating process. In one non-limiting example of a rod coating process the temporary decoration may be made by a Mayer rod coating process and then laser cut into the desired pattern as follows:

a) Lay a piece of backing on a flat surface such as a table. Apply Transfer Lacquer to the top of the backing in a line similar in length to that of the Mayer rod. A suitable Mayer rod for this purpose is the #18 Wet Film Applicator Rod available from Gardco, Paul N. Garner Company Incorporated of Pompano Beach, Fla. Pull the Mayer rod in the y-axis direction so as to form a layer of uniform thickness on the backing. The layer is then allowed to dry for thirty minutes.
b) After the transfer lacquer is dry, a coating such as PERMA WET Gloss Coating is then applied to the backing in a similar manner as described in step a). The backing to which the transfer lacquer and coating have been applied is then allowed to dry for sixty minutes.
c) After the coating is dry a colorant, one non-limiting example of which is an ink (such as an ink from the FIDELITY line of inks), is applied to the backing in a similar manner as described in step a). This layer is allowed to dry for thirty minutes.
d) After the ink is dry, a pressure sensitive adhesive, such as ROBOND PS-8915, is then applied to the backing on which the transfer lacquer, coating, and ink have already been applied. The adhesive is applied to the backing in a similar manner as described in step a). This layer is allowed to dry for twelve hours.
e) A release sheet is then applied to the backing to which the transfer lacquer, coating, ink and adhesive have already been applied.
f) This is then laser cut to a desired pattern to create the temporary decoration. A suitable laser for this purpose is Laser Model No. X2-660 available from Universal Laser System of Scottsdale, Ariz.

### Method of Applying the Temporary Decoration to Fabric

The temporary decoration of the present invention may be applied to the fabric by removing the release sheet of the temporary decoration. The temporary decoration is then applied to the fabric such that the adhesive layer (i.e.; sticky side of the temporary decoration) contacts the fabric in the desired location. The user then rubs their finger nail or other rubbing implement, non-limiting examples of which include a coin, popsicle stick, or the like across the temporary decoration so as to transfer the design to the fabric. The user can then check on the transferring process by lifting up the corner of the backing sheet to check that the entire design has transferred to the fabric. If the entire design has not transferred, the backing sheet is then placed back on top of the design and the user can continue to rub their finger nail across the temporary decoration with more force. A typical force required to transfer the design portion of the temporary decoration to the fabric is generally from about 5 Newtons/cm² to about 25 Newtons/cm². Once the entire design has transferred to the fabric the backing sheet may be removed. If needed, the user can utilize their hand to smooth the edges of the transferred design.

It may be desirable to provide a visual signal to the user that the design has adequately transferred to the fabric. In a certain embodiment specific combinations of release agent, ink and adhesive can be chosen to maximize the visual signal. While not wishing to be bound by theory it is believed that if Young's Modulus as measured via the standard ASTM method set out below is too low, there will be no visual signal (i.e. visible lightening of the design as pressure is applied and it is released from the backsheet. Alternatively, it has been found that if the modulus is too high there will be pre-release from the back sheet before intended application to the fabric. In order to maximize the visual signal to the consumer it is preferable for the modulus to be in the range of from about 12.5 ksi to about 37.5 ksi, more preferably from about 12.5 ksi to about 24.7 ksi.

### Method of Determining Modulus:

Measurement of Young's modulus is made by using tensile testing instrument and following the protocols set forth in ASTM D2370-98 (Standard Test Method for Tensile Properties of Organic Coatings) and ASTM E111-04 (Standard Test Method for Young's Modulus, Tangent Modulus, and Chord Modulus). The test specimens were prepared following D2370-98 section 11.1-11.5. The specimens are 25.4 mm wide and 101.6 mm long with the tested gage length set to 50.8 mm. The rate of elongation is set to 25.4 mm/minute (elongation rate of 50%). For Young's modulus calculations, follow section 9.1 of E111-04.

Method of Removing the Temporary Decoration from the Fabric

The temporary decoration of the present invention may be removed from the fabric with water. This may be accomplished in any number of ways. For instance, in one non-limiting example the design containing portion of the fabric is held under running water such as under a sink faucet. In another non-limiting example, the design containing portion of the fabric may be placed in a sink or other container filled with water. In yet another non-limiting example, a removal implement, one non-limiting example of which is a pad, may be used to facilitate removal of the temporary decoration from the fabric. The pad may include a textured side. If used, the pad may be wetted with water by soaking it or placing it under a running faucet. The water used to wet the pad may be warm or cold. The textured side of the wetted pad is then applied to the design portion of the fabric. Using the textured side of the pad, the user then may gently wipe the design away. To help facilitate the removal process, it may be desirable for the user to start the wiping process on the outside of the design and wipe in one direction toward the center of the design. Additionally, to further facilitate removal, additional moisture can be added to the pad and/or the fabric in order to help facilitate the release of the design from the fabric.

One non-limiting suitable pad for this purpose is comprised of multiple layers. The first or top layer may be comprised of polypropylene netting material. A suitable polypropylene netting material is a 30 gsm polypropylene material sold as DELNET RC 0707-20P and available from Delstar Technologies Incorporated of Middletown, Del. This first layer may be thermally bonded to a second layer comprising two layers of a 60 gsm 50% polypropylene/50% Rayon spunlace available from Precision Fabrics Group Incorporated of Greensboro, N.C. This structure may be made using techniques disclosed for example in U.S. 2007/0009708 published on Jan. 11, 2007 in the name of Dorsey et al.

A third layer may be bonded to the combined first layer and second layer on the second layer side. Third layer may be comprised of a 135 gsm airlaid core sold as TBAL 135 and available from Glatfelter Gatineau Limited of Gatineau, Quebec, Canada. A fourth layer may be combined to the third layer side of the first layer, second layer, third layer combination. The fourth layer may be comprised of 48 gauge polyethylene terephthalate/2 mil (15 microns) linear low density polyethylene film and sold as M1415 Plain available from Alcan/Bemis of Neenah, Wis. The combined first layer, second layer, third layer, and fourth layer may then be heat sealed. One suitable piece of equipment which may be used for heat sealing is sold as PW 5000 available from Packworld USA of Nazareth, Pa.

In an alternate non-limiting embodiment of the pad described above, the combined first layer and second layer are cut to a 2.375 inch by 2.375 inch (6.033 cm by 6.033 cm) square. The linear low density polyethylene film side of the fourth layer is placed against the smooth side of the combined first layer/second layer. Three sides of this combination are then heat sealed using the Packworld PW 5000 heat sealer with a 0.25 inch (6.35 mm) width sealing strip using heat sealer settings of 110° C. for 2 seconds at 30 psi and 80° cooling. Using a die cutter (available from WDS of Harrison, Ohio) and an ATOM press (¼ setting) (ATOM press model No. SE 20C available from Atom S.P.A. of Via Morosini, Italy) to die cut the TBAL 135 third layer into a 1.75 inch (4.45 cm) square. The third layer is then slid into the open side between the fourth layer and the combined first layer/second layer. The open side is then heat sealed with the heat sealer using the same conditions as described above to form the pad. If desired, the edges of the pad can be rounded by die cutting using a rounded edge 2 inch (5 cm) die with a 0.125 inch (3.175 mm) corner radius and the ATOM Press.

### Kit

The temporary decoration may be provided as a kit for instance in conjunction with a removal pad. Alternatively, the temporary decoration may be provided and/or sold separately. Likewise, if utilized, the removal pad may also be provided and/or sold separately.

### Self-Instructing Article of Commerce

The present invention also encompasses articles of commerce comprising 1) the temporary decoration of the present invention, and 2) a set of instructions directing the user how to utilize the temporary decoration.

In one embodiment, the article of commerce comprises the temporary decoration of the present invention in association with a set of instructions, wherein the instructions direct the user to follow the method of utilizing the temporary decoration. The instructions may be in the form of written words, pictorials, symbols/icons, and the like, as well as combinations thereof. In one non-limiting embodiment, such instructions may direct the user how to apply the temporary decoration to fabric. The instructions may also direct the user how to remove the temporary decoration from the fabric. Furthermore, the instructions may direct the user how to utilize a removal pad to remove the temporary decoration from the fabric.

Herein, “in association with”, when referring to such instructions, means the instructions are either directly printed on the temporary decoration; directly printed on the packaging for the temporary decoration; printed on a label attached to the temporary decoration or the packaging for the temporary decoration; or presented in a different manner including, but not limited to, a brochure, print advertisement, electronic advertisement, broadcast or internet advertisements, and/or other media, so as to communicate the set of instructions to a consumer of the temporary decoration.

### Test Methods

The following test methods may be used in conjunction with the temporary decoration of the present invention:

### A. Fabric Used in Testing

The fabric used for testing should be a 98% Cotton/2% Spandex dark blue denim, weighing 330 to 460 g/m², with right-hand twill direction, and a stiffness value of 80 to 150 g (as measured by the method given here-in). Such denim fabric is often used in women's denim blue jeans. A suitable fabric is Stretch Denim Swatches, available from Fuyang Import & Export Company, Ltd. in Fuyang, Hangzhou, China. Before use, the fabric is washed in AATCC 1993 Standard Reference Detergent WOB (Without Optical Brighteners) (AATCC, Research Triangle Park, NC, USA) using a top loading washing machine. The fabrics are washed in warm water (approximately 32° C.) with about 64.4 liters of water of approximately 137 ppm hardness on a normal agitation cycle (approximately 12 minutes), using the recommended AATCC detergent dosage (according to the weight of fabric per load), and rinsed with cold water. The above cycle is repeated with detergent at the same temperature, hardness, and agitation. The fabrics are then washed for 2 more cycles with only water (i.e.; without added detergent), under the same water, temperature, hardness, and agitation conditions. The fabrics are dried in a front loading dryer (e.g. one non-limiting example of which is a Kenmore 70 series available from Sears of Hoffman Estates, Ill.) using the normal/permanent press cycle (medium heat) for 45 minutes. The fabric should be stored such that it is kept flat, dry and cool, and used for testing within 18 months of purchase.

### B. Mandrel Bend Method

Measurement of the temporary decoration's resistance to cracking is made using cylindrical mandrels, following the method protocol of ASTM D522-93a—Standard Test Methods for Mandrel Bend Test of Attached Organic Coatings, Test Method B—Cylindrical Mandrel Test. Follow the testing procedure described in ASTM D522-93a test method B, with the following selections and modifications. Skip Sections 5.1.1, 14, 15.1.1, 15.1.2, and 15.1.5, since percent of elongation is not the focus of this testing. In Sections 5.1.2 and 5.1.3 use a bare aluminum test panel with the dimensions 0.64 mm thick, by 102 mm wide by 203 mm long as the rigid surface test panel onto which the temporary decoration will be applied prior to cracking measurement. A suitable test panel is the Q-Panel brand, part number PP-08-04x08, available from Gardco/The Paul N Gardner Company Inc., in Pompano Beach, Fla., USA. This test panel is composed of alloy 3105 H14, with nominal yield strength of 159 Mpa, and tensile strength of 179 Mpa. Replace ASTM Section 5.2 with the preparation protocol indicated below.

### Preparation Protocol for Mandrel Bend Test Specimens:

1) Select a large contiguous area of the temporary decoration which lacks breaks or holes in the film. Cut samples of the transfer from within this contiguous area, including any protective sheets, backing sheets or adhesive layers. Cut the temporary decoration to yield samples with dimensions of 8.2 cm by 1.6 cm using a sharp single blade knife, such as a box cutter, craft knife, razor blade or scalpel. Do not use scissors or any other multiple-blade devices to cut the temporary decoration. The cut edges must pass through colored or opaque areas of the temporary decoration design and avoid selecting transparent or clear areas as much as possible. If the temporary decoration dimensions are insufficient to yield a single sample piece meeting the size requirements indicated, then cut samples which are as similar as possible to the indicated size, and increase the number of replicates tested to compensate for the smaller sample size.
2) Use a bare aluminum test panel with the dimensions 0.64 mm thick, by 102 mm by 203 mm as the rigid surface test panel onto which the temporary decoration will be applied prior to measurement. A suitable test panel is the Q-Panel brand, part number PP-08−04×08, available from Gardco/The Paul N Gardner Company Inc., in Pompano Beach, Fla., USA. This test panel is composed of alloy 3105 H14, with nominal yield strength of 159 Mpa, and tensile strength of 179 Mpa.
3) Confirm that the test panel's surface is clean, dry and free of defects.
4) If there is a backing sheet protecting the adhesive or ‘sticky’ side of the temporary decoration sample, peel off and discard that protective sheet from the cut sample.
5) Place the adhesive face of the cut sample in contact with test panel. Ensure that the sample is centered on the test panel such that the longer side of the temporary decoration sample is parallel to the longer edge of the test panel and that the temporary decoration sample covers the center of the test panel.
6) Use a hand roller weighing 2.04 Kg and with roller dimensions of 95 mm diameter by 45 mm wide. A suitable roller composed of a steel core with a silicone rubber cover is available from ChemInstruments Incorporated of Fairfield, Ohio. Confirm that the roller surface is clean, dry and free of lint, dirt or defects.
7) If insufficient sample exists to meet the sample size requirements laid out above, and as such the width of the test specimen is less than 1.6 cm, then use a hand roller of appropriate weight to obtain a line pressure equivalent to 2.04 Kg for 1.6 cm of sample width, ±35%.
8) Adhere the temporary decoration sample to the metal test panel by making two passes over the sample with the hand roller in the long axis direction of the sample, at a rate of 61 cm/minute, without applying any additional vertical force nor lessening the inherent force/weight of the roller on the sample.
9) If there is a protective sheet covering the upper surface of the temporary decoration sample design, peel off that protective sheet such that only the temporary decoration design remains on the test panel.
Follow the procedure described in ASTM D522-93a Section 6 with the following modifications: Prior to taking measurements, allow the test panel with adhered samples to equilibrate for 15 minutes in a controlled temperature and humidity room at 20±2° C., and 65±5% RH, and measure the sample using the cylindrical mandrel bend method on the same day the sample is prepared. Test at least two replicate specimens each sourced from different sheets or batches of product, i.e.; samples cut from a single packaged sheet of product are not to be considered as replicates.

Follow the procedure described in ASTM D522-93a Sections 13 and 15, with the following modifications: In Section 13.1, use at least a 2.54 cm (1 inch) overhang on either side and use a new untested specimen for each test attempt. In Section 15, report the smallest diameter at which the sample did not fail. Failure of the sample includes any fracture, crazing, cracking or similar change that is visible to the naked eye. A failure can occur at any time during the bending of the test specimen over the mandrel. If the sample fails on the 2.54 cm mandrel, then report this as well.

### C. 90° Peel Method

The 90° peel method is used to measure the force (i.e.; ease of release) needed to separate the graphic/design-containing portion of the temporary decoration (i.e., the facestock or face material) from the backing sheet portion of the temporary decoration (which may be clear or transparent) which carries the temporary decoration graphic design to the fabric. The sample for this test is prepared by using a 2 Kg controlled pressure roller device to adhere the graphic/design portion of the temporary decoration to the denim fabric in a reproducible manner. A suitable device is a Rolldown model RD-3000, as supplied by ChemInstruments Incorporated of Fairfield, Ohio, having 2 Kg rubber-coated steel rollers. Cut a 51 mm by 165 mm rectangle swatch of denim fabric, oriented such that the long axis of the rectangle swatch is cut perpendicular to the direction of the denim's grey weft yarns. Select a large contiguous area of the temporary decoration graphic face material which lacks breaks or holes in the film. Cut samples of the temporary decoration from within this contiguous area, including any adhesive-protecting sheet, temporary decoration-carrying backing sheet or other layers that may be present. Use a sharp single-blade knife or scalpel to cut out a 25.4 mm by 127 mm rectangular sample of the temporary decoration product to be tested. The cut edges must pass through colored or opaque areas of the temporary decoration and avoid selecting transparent or clear areas as much as possible. Equilibrate both the temporary decoration sample and the fabric swatch in an environment with temperature of 22±5° C. and humidity of 15 to 40% RH, for at least 2 hours prior to adhering them together. Set up one cycle on the pressure roller device, with a stroke speed of approximately 61 cm per minute and a stroke length of approximately 15 cm. Peel off any adhesive-protecting sheet covering the temporary decoration's adhesive surface, then place the adhesive side of the temporary decoration sample onto the blue surface (face) of the denim, centered in the middle of the fabric swatch, leaving the temporary decoration carrying backing sheet attached. Place the denim and temporary decoration sample on the pressure roller device and run the cycle. The temporary decoration sample is then ready for the peel force measurement test, which should be conducted on within 1 hour of the temporary decoration being adhered to the fabric, and under the same environmental conditions. The peel force measurement is conducted by using a Tensile Testing instrument, (a suitable example is model 55012/1122 by Instron Corporation of Norwood, Mass.). Mount the prepared denim-temporary decoration sample into the tensile tester instrument such that both short edges of the denim swatch are clamped to hold the fabric in a constant position and one short edge of the temporary decoration-carrying backing sheet will be peeled back from the fabric at a 90° angle. Run the peel adhesion test on the tensile tester according to the standard protocol ASTM D6252/D6252M-98 (2004), referring only to Sections 1 through 5, and Sections 6.5 and 9. Record the load force required to peel off the backing sheet during the test run, taking the initial reading at the 25.4 mm location, and additional readings at each 12.7 mm interval thereafter, in accordance with ASTM D6862-04: Section 9. The force needed to separate the temporary decoration graphic from the backing sheet for that replicate sample is the average of all readings in that run. Five replicate samples are tested for each temporary decoration product and the replicates averaged to determine the result for that product.

### D. Thickness Measurement Via Caliper Method

Measurement of the graphic containing portion of the temporary decoration's thickness is made using a micrometer, following the method protocol of ASTM D1005-95 (Measurement of Dry-Film Thickness of Organic Coatings Using Micrometers). Follow those portions of the ASTM that are indicated for Procedure C (Hand held micrometer for measuring coatings applied to plane rigid surfaces). Replace ASTM Sections 5.1 and 5.1.1 with the preparation protocol indicated below:

### Preparation Protocol for Micrometer Test Specimens:

1) Select a large contiguous area of the temporary decoration which lacks breaks or holes in the film. Cut samples of the temporary decoration from within this contiguous area, including any protective sheets, backing sheets or adhesive layers. Cut the temporary decoration to yield samples with dimensions of 8.2 cm by 1.6 cm using a sharp single blade knife, such as a box cutter, craft knife, razor blade or scalpel. Do not use scissors or any other multiple-blade devices to cut the temporary decoration. The cut edges must pass through colored or opaque areas of the temporary decoration graphic-containing portion/design. Avoid selecting transparent or clear areas as much as possible. If the temporary decoration dimensions are insufficient to yield a single sample piece meeting the size indicated, then cut several rectangular samples which are as similar as possible to the indicated size, and arrange them in such a way as to mimic the placement instructions outlined below.
2) Use a bare aluminum test panel with the dimensions 0.64 mm thick, by 102 mm by 203 mm as the rigid surface test panel onto which the temporary decoration will be applied prior to measurement. A suitable test panel is the Q-Panel brand, part number PP-08-04x08, available from Gardco/The Paul N Gardner Company Inc., o Pompano Beach, Fla., USA. This test panel is composed of alloy 3105 H14, with nominal yield strength of 159 Mpa, and tensile strength of 179 Mpa.
3) Confirm that the test panel's surface is clean, dry and free of defects.
4) On the reverse face of the test panel, (i.e.; the face where the sample will not be applied), draw 2 lines using a permanent marker pen, making both lines 20 cm long, and parallel to the longest sides. Locate one line 13 mm in from one of the longest edges and locate the other line 13 mm in from the other longest edge.
5) On this same face, also, draw a 10 cm line that is parallel to the short edges of the test panel and is located 70 mm from the short edge that does not have the hole (if a hole is present). Also draw another three 10 cm lines that are also parallel to the short edge, such that the four 10 cm lines are evenly spaced 20 mm apart.
6) Using a micrometer accurate to 2 μm, such as a Digimatic Micrometer Series 293 MDC-Lite (available from Mitutoyo of Aurora, Ill.), measure and record the thickness at the eight intersection points where the lines drawn in steps 4 and 5 cross each other.
7) If there is a backing sheet protecting the adhesive or ‘sticky’ side of the temporary decoration sample, peel this off and discard that protective sheet from the cut sample.
8) Place the adhesive face of the cut sample in contact with the face of the test panel that does not have any lines. Ensure that the temporary decoration sample is placed on the test panel such that the longer side of the sample is parallel to the longer edge of the test panel, and that the long edge of the temporary decoration is 5 mm from the longer edge of the test panel, and the shorter edge is 60 mm from the shorter edge of the test panel that does have not have a hole. Repeat for the other long edge such that there are two samples adhered onto one face of a single test panel, and that each of the line intersection points occur behind an area covered by the temporary decoration sample.
9) Use a hand roller weighing 2.04 kg and with roller dimensions of 95 mm diameter by 45 mm wide. A suitable roller composed of a steel core with a silicone rubber cover is available from ChemInstruments Incorporated of Fairfield, Ohio. Confirm that the roller surface is clean, dry and free of lint, dirt or defects.
10) If insufficient sample exists to meet the sample size requirements laid out above and as such the width of the test specimen is less than 1.6 cm, then use a hand roller of appropriate weight to obtain a line pressure equivalent to 2.04 Kg for 1.6 cm of sample width, ±35%.
11) Adhere the temporary decoration sample to the metal test panel by making 2 passes over the sample with the hand roller in the long axis direction of the sample, at a rate of 61 cm/min, without applying any additional vertical force or lessening the inherent force/weight of the roller on the sample.
12) If there is a protective sheet covering the upper surface of the temporary decoration sample design, peel off that protective sheet such that only the temporary decoration design remains on the test panel.
13) Allow the test panel with the adhered samples to equilibrate for 15 minutes in a controlled temperature and humidity room at 20±2° C., and 65±5% RH.
   Follow the measurement procedure described in Section 6.3.6 of ASTM D1005-95, to use the drawn lines as a guide to re-measure and record the total thickness at the 8 different points that were measured in the preparation step 6. The differential between the two measurements at each point yields the thickness of the sample in that location. Measure a minimum of 4 locations per sample.

### E. Stiffness Measurement—Blade/Slot Method

The blade/slot method determines stiffness (also known as handle—a combined stiffness and friction measure) by measuring the force required to push a specimen into a slot of predetermined width with a metal blade, in accordance with the standard procedure ASTM D6828-02 (Reapproved 2007). The test may be performed using a device such as a Handle-o-meter Tester model 211-300 (available from Thwing-Albert Instrument Company of Philadelphia, Pa.). The stiffness of a temporary decoration sample is measured by using the blade/slot method on denim fabric before and after the application of the temporary decoration sample, then calculating the differential between the two measurements. Set up the test instrument with a 10 mm slot width and either a 100 gm or 1000 gm beam. Samples yielding an individual measurement of greater than 100 gm should be measured using the 1000 gm beam.

The stiffness of the denim alone, without any applied temporary decoration is measured by the following steps. Cut denim fabric into at least five squares, each square being 51 mm by 51 mm, aligning the cut edges of each square parallel to the warp and weft of the denim fabric. Using these 51 mm denim squares, run the stiffness test according to ASTM D6828, following sections 1 though 6, plus sections 8, 10, and 11, and omitting sections 7 and 9, in an environment with a relative humidity of 20 to 40% RH. The stiffness of denim with adherent temporary decoration is then measured by cutting a 19 mm by 51 mm rectangle sample of the temporary decoration product, then removing any adhesive-protecting sheet, and placing the temporary decoration so that it is approximately in the middle of a denim square that has had its stiffness measured already, with the 51 mm side of the temporary decoration sample parallel with the denim's warp direction. Adhere the temporary decoration sample to the denim via firm hand-burnishing and peel off the carrier backing sheet. The stiffness value of each denim square is re-measured after the application of a temporary decoration sample, employing the same procedure used to measure the fabric prior to application of the temporary decoration.

The stiffness value in grams, of the temporary decoration sample is then determined for each denim square individually, by calculating the differential (delta) in stiffness value measured for that denim square before and after the application of the temporary decoration, using the following equation:

Stiffness_{temporary decoration}=Stiffness_{denim with temporary decoration}−Stiffness_{denim}

The temporary decoration's stiffness value is calculated for at least four replicate temporary decoration samples, and these values are averaged to determine the stiffness value of the temporary decoration product.

### EXAMPLES

Non-limiting examples relating to the temporary decoration of the present invention are disclosed below.

### Example 1

a) Utilize a 158 mesh size screen that includes a pattern or desired indicia.
b) Lay a piece of backing underneath the screen and line up the backing with the registration marks on the screen.
c) Bring the screen down over the backing. A clear release agent comprised of a mixture of 60% DA170 (Hexanedioic acid polymer containing composition) available from Nazdar Company of Shawnee, Kans.) and 40% DA176 (toluene 2,6-diisocyanate containing composition) available from Nazdar Company is applied to the top of the screen in the non-patterned region of the screen. A squeegee is used in one stroke to apply the release agent through the screen to the backing so as to form a layer of uniform thickness.
d) Raise the screen and remove the backing with the release agent layer applied thereto and place it onto a drying rack to cure for twenty-four hours.
e) Take the backing from the drying rack, lay it down underneath the screen and line up the registration marks.
f) The screen is brought down over the backing. An ink comprising 77% DALF104 (Hexanedioic acid polymer containing composition with colorant available from Nazdar Company) with 19% DA176 (toluene 2,6-diisocyante containing composition available from Nazdar Company) and 4% RE188 (thinner available from Nazdar Company) is applied to the top of the screen in the non-patterned region of the screen. A squeegee is used in one stroke to apply the ink through the screen to the backing so as to form a layer of uniform thickness.
g) Raise the screen and remove the backing which now has the release layer and an ink applied thereto and place it onto a drying rack to cure for twenty-four hours.
h) Take the backing from the drying rack, lay it down underneath the screen and line up the backing with the registration marks on the screen.
i) Utilize a 60 mesh screen that includes a pattern or desired indicia and bring the screen down over the backing to which the release agent layer and ink have already been applied thereto. Apply an adhesive comprising an aqueous based copolymer of vinyl acetate and acrylic ester (SP7533 available from 3M of St. Paul, Minn.) to the top of the screen in the non-patterned region of the screen. A squeegee is used in one stroke to apply the adhesive through the screen to the backing so as to form a layer of uniform thickness.
j) Raise the screen and remove the backing which now has the release layer, ink, and pressure sensitive adhesive applied thereto and place it onto a drying rack to cure for twelve hours.
k) Remove the backing with the subsequent layers of release agent, ink, and adhesive from the drying rack and apply a release sheet.

### Example 2

a) Utilize a 158 mesh size screen that includes a pattern or desired indicia.
b) Lay a piece of backing underneath the screen and line up the backing with the registration marks on the screen
c) Bring the screen down over the backing. A clear release agent comprised of a mixture of 70% DA170 (Hexanedioic acid polymer containing composition available from Nazdar Company of Shawnee, Kans.) and 30% DA176 (toluene 2,6-diisocyanate containing composition available from Nazdar Company) is applied to the top of the screen in the non-patterned region of the screen. A squeegee is used in one stroke to apply the release agent through the screen to the backing so as to form a layer of uniform thickness.
d) Raise the screen and remove the backing with the release agent layer applied thereto and place it onto a drying rack to cure for twenty-four hours.
e) Take the backing from the drying rack, lay it down underneath the screen and line up the registration marks.
f) The screen is brought down over the backing. An ink comprising 77% DALF104 (Hexanedioic acid polymer containing composition with colorant available from Nazdar Company) with 19% DA176 (toluene 2,6-diisocyante containing composition available from Nazdar Company) and 4% RE188 (thinner available from Nazdar Company) is applied to the top of the screen in the non-patterned region of the screen. A squeegee is used in one stroke to apply the ink through the screen to the backing so as to form a layer of uniform thickness.
g) Raise the screen and remove the backing which now has the release layer and an ink applied thereto and place it onto a drying rack to cure for twenty-four hours.
h) Take the backing from the drying rack, lay it down underneath the screen and line up the backing with the registration marks on the screen.
i) Utilize a 60 mesh screen that includes a pattern or desired indicia and bring the screen down over the backing to which the release agent layer and ink have already been applied thereto. Apply an adhesive comprising an aqueous based copolymer of vinyl acetate and acrylic ester (SP7533 available from 3M of St. Paul, Minn.) to the top of the screen in the non-patterned region of the screen. A squeegee is used in one stroke to apply the adhesive through the screen to the backing so as to form a layer of uniform thickness.
j) Raise the screen and remove the backing which now has the release layer, ink, and pressure sensitive adhesive applied thereto and place it onto a drying rack to cure for twelve hours.
k) Remove the backing with the subsequent layers of release agent, ink, and adhesive from the drying rack and apply a release sheet.

### Example 3

a) Utilize a 110 mesh screen that includes a pattern or desired indicia.
b) Lay a piece of backing underneath the screen and line up the backing with the registration marks on the screen.
c) Bring the screen down over the backing and apply a clear release agent (7227 MIXING/OVERPRINT CLEAR available from the Nazdar Company of Shawnee, Kans.) to the top of the screen in the non-patterned region of the screen. Using a squeegee apply the release agent through the screen to the backing in one stroke of the squeegee so as to form a layer of uniform thickness.
d) Raise the screen and remove the backing with the release agent applied thereto and place it onto a drying rack to cure for one hour.
e) Take the backing from the drying rack, lay it down underneath the 110 mesh screen and line up the registration marks.
f) Bring the screen down over the backing and apply SYMPHONY blue ink (Chemical code ESRFW5837676 available from Sun Chemical Corporation of Carlstadt, N.J.) to the top of the screen in the non-patterned region of the screen. Using a squeegee apply the ink through the screen to the backing in one stroke of the squeegee so as to form a layer of uniform thickness.
g) Raise the screen and remove the backing which now has the release layer and an ink applied thereto and place it onto a drying rack to cure for one hour.
h) Take the backing from the drying rack, lay it down underneath the screen and line up the backing with the registration marks on the screen
i) Using the same 110 mesh screen bring the screen down over the backing to which the release agent and ink have already been applied thereto and apply a pressure sensitive adhesive comprising an aqueous acrylic emulsion (ROBOND PS-8915 adhesive available from The Dow Chemical Company of Buffalo Grove, Ill.). Using a squeegee apply the adhesive through the screen to the backing with one stroke of the squeegee so as to form a layer of uniform thickness.
j) Raise the screen and remove the backing which now has the release agent, ink, and pressure sensitive adhesive applied thereto and place it onto a drying rack to cure for twelve hours.
k) Remove the backing with the subsequent layers of release agent, ink, and adhesive, and add the release sheet.

### Example 4

a) A piece of backing is placed on a table surface. A release layer (OPTICOLOR Transfer Lacquer available from Central Chemical & Service Corporation of Carol Stream, Ill.) is applied to the top of the backing in a line similar in length to that of a Mayer Rod (Mayer Rod #18 Wet Film Applicator Rod available from Gardco, Paul N. Garner Company Incorporated of Pompano Beach, Fla.). The Mayer rod is pulled in the y-axis direction so as to allow the OPTICOLOR Transfer Lacquer to create a release agent layer or release layer of uniform thickness on the backing. The layer is then allowed to dry for thirty minutes.
b) After the release agent layer is dry, a protective layer (PERMA WET Gloss Coating available from The Monster Makers, Incorporated of Lakewood, Ohio) is then applied to the backing in a similar manner as described in step a). The backing to which the transfer lacquer and coating have been applied is then allowed to dry for sixty minutes.
c) After the protective layer is dry an ink (FIDELITY Orange ink Product Code No. HF02300000 available from Sun Chemical Corporation of Carlstadt, N.J.) is applied to the backing in a similar manner as described in step a). This layer is allowed to dry for thirty minutes.
d) After the ink is dry, a pressure sensitive adhesive (ROBOND PS-8915 available from Dow Chemical Company of Buffalo Grove, Ill.) is then applied to the backing on which the release agent layer, coating, and ink have already been applied. The adhesive is applied to the backing in a similar manner as described in step a). This layer is allowed to dry for twelve hours.
e) A release sheet is then applied to the backing to which the transfer lacquer, protective layer, ink and adhesive have already been applied.
f) This is then laser cut to the desired pattern to create the temporary decoration using Laser Model No. X2-660 available from Universal Laser System of Scottsdale, Ariz.

TABLE 1

| | | | | Stiffness of | | Thickness of |
|---|---|---|---|---|---|---|
| | | | | Denim with | | Design |
| | | | | Temporary | Stiffness of | Containing |
| | | | Stiffness | Decoration | Temporary | Portion of |
| | Mandrel | 90° Peel | of Denim | applied thereto | Decoration | Decoration |
| Example | Bend | (Newtons) | (Grams) | (Grams) | (Grams) | (Microns) |
| No. | (n = 3) | (n = 5) | n = 4 | n = 4 | n = 4 | (n = 4) |
| 1 | No | 0.19 ± 0.02 | 109.6 | 298.1 | 188.5 ± 12.0 | 71.5 ± 0.6 |
| | Cracking- | | | | | |
| | ⅛″ | | | | | |
| | mandrel | | | | | |
| 2 | No | 0.33 ± 0.03 | 101.0 | 175.4 | 74.4 ± 5.3 | 69.0 ± 2.2 |
| | Cracking- | | | | | |
| | ⅛″ | | | | | |
| | mandrel | | | | | |
| 3 | Cracking- | 0.15 ± 0.02 | 94.7 | 129.6 | 34.9 ± 3.0 | 60.3 ± 4.3 |
| | 1″ mandrel | | | | | |
| 4 | No | 0.07 ± 0.01 | 106.5 | 266.3 | 159.8 ± 12.6 | 34.3 ± 2.3 |
| | Cracking- | | | | | |
| | ⅛″ | | | | | |
| | mandrel | | | | | |

Table 1 represents examples of the temporary decoration of the present invention which are made according to the procedures disclosed in Examples 1-4 of the Detailed Description and which are then tested for Mandrel Bend, 90° Peel, Stiffness, and Thickness in accordance with the test methods disclosed in the Test Methods section of the Detailed Description. Standard Deviations for each test result are shown next to the result as ±.

TABLE 2

| | | | | Stiffness of | | |
|---|---|---|---|---|---|---|
| | | | | Denim with | | Thickness of |
| | | | | Temporary | | Design |
| | | | | Decoration | Stiffness of | Containing |
| | | | Stiffness | applied | Temporary | Portion of |
| | Mandrel | 90° Peel | of Denim | thereto | Decoration | Decoration |
| Comparative | Bend | (Newtons) | (Grams) | (Grams) | (Grams) | (Microns) |
| Samples | (n = 3) | (n = 5) | n = 4 | n = 4 | n = 4 | (n = 4) |
| 1* | Cracking- | 0.13 ± 0.01 | 98.5 | 283.2 | 184.7 ± 16.7 | 29.0 ± 0.8 |
| | 1″ mandrel | | | | | |
| 2** | Cracking- | 0.17 ± 0.01 | 93.1 | 214.5 | 121.4 ± 7.5 | 33.1 ± 1.0 |
| | 1″ mandrel | | | | | |
| 3*** | Cracking- | NA**** | 94.0 | 194.9 | 100.9 ± 8.5 | 25.0 ± 0.8 |
| | ¾″ | | | | | |
| | mandrel | | | | | |

*Comparative Sample No. 1 sold as Hambly Rub-Ons - Gold Sewing R544 available from Hambly Screen Prints of Santa Clara, California, www.HamblyScreenPrints.com.
**Comparative Sample No. 2 sold as Hambly Rub-Ons - Pink Sewing R545 available from Hambly Screen Prints of Santa Clara, California, www.HamblyScreenPrints.com.
***Comparative Sample No. 3 sold as K&Company Fall Harvest Words & Phrases Rub-on available from www.eksuccessbrands.com/kandcompany/.
****Comparative Sample No. 3 could not be tested via the 90° Peel Test because the only samples available were not long enough (>5″).

Table 2 represents comparative samples which are tested for Mandrel Bend, 90° Peel, Stiffness, and Thickness in accordance with the test methods disclosed in the Test Methods section of the Detailed Description. Standard Deviations for each test result are shown next to the result as ±.

Table 3 below represents comparative examples wherein a preferred visual signal is sometimes present but the samples exhibited undesirable cracking and/or was difficult to release from the backing sheet.

TABLE 3
Comparative examples sometimes providing a visual
signal but not reliably and with cracking.

| | | | modulus | Visual | mandrel | mandrel |
|---|---|---|---|---|---|---|
| Release Agent | Ink | Adhesive | (ksi) | signal | bend ¾″ | bend ½″ |
| Matsui Stretch Clear | Nazdar DA Series | 3M SP7533 | 0.0896 | No | No crack | No crack |
| | 77% DALF104, | | | | | |
| | 19% DA176, 4% | | | | | |
| | RE188 | | | | | |
| 3M Screen Print | Nazdar DA Series | 3M SP7533 | 3.3707 | sometimes | No crack | No crack |
| Gloss Clear 9720 UV | 77% DALF104, | | | | | |
| | 19% DA176, 4% | | | | | |
| | RE188 | | | | | |
| 3M Screen Printing | Nazdar DA Series | 3M SP7533 | 4.8226 | No | No crack | No crack |
| UV Ink Series | 77% DALF104, | | | | | |
| 9800CL Screen Print | 19% DA176, 4% | | | | | |
| Clear | RE188 | | | | | |
| Matsui Stretch Clear | Colorcon NT28 | Cox Sales Co. | 8.5782 | No | Crack | Crack |
| | No-Tox Paper/ | AM-CO45-2 | | | | |
| | Posterboard Red | adhesive | | | | |
| | Ink | | | | | |
| Colorcon NT28 No- | Colorcon NT28 | Cox Sales Co. | 12.6164 | sometimes | Crack | Crack |
| Tox Paper/ | No-Tox Paper/ | AM-CO45-2 | | | | |
| Posterboard Inks | Posterboard Red | adhesive | | | | |
| Clear | Ink | | | | | |
| 3M Screen Print | Colorcon NT28 | Cox Sales Co. | 13.415 | sometimes | No crack | No crack |
| Gloss Clear 9720 UV | No-Tox Paper/ | AM-CO45-2 | | | | |
| | Posterboard Red | adhesive | | | | |
| | Ink | | | | | |
| Nazdar Mixing | Sun Chemical | Rohm & Haas | 57.7199 | Yes | Crack | Crack |
| Overprint Clear | Symphony blue | Robond PS- | | | | |
| | ink | 8915 adhesive | | | | |

Table 4 below represents samples in accordance with the invention that exhibit both a preferred visual signal and no cracking under the previously discussed mandrel bend test.

TABLE 4
Examples exhibiting a preferred visual signal and no cracking

| | | | | | | mandrel |
|---|---|---|---|---|---|---|
| | | | modulus | Visual | mandrel | bend |
| Release Agent | Ink | Adhesive | (ksi) | signal | bend ¾″ | ½″ |
| Nazdar DA Series | Nazdar DA | 3M SP7533 | 12.6956 | Yes | No crack | No crack |
| 60% DA170, | Series 77% | | | | | |
| 40% DA176 | DALF104, | | | | | |
| | 19% DA176, | | | | | |
| | 4% RE188 | | | | | |
| 3M Screen | Colorcon | Cox Sales | 18.5389 | Yes | No crack | No crack |
| Printing UV Ink | NT28 No- | Co. AM- | | | | |
| Series 9800CL | Tox Paper/ | CO45-2 | | | | |
| Screen Print Clear | Posterboard | adhesive | | | | |
| | Red Ink | | | | | |
| Nazdar DA Series | Colorcon | 3M SP7533 | 24.731 | Yes | No crack | No crack |
| 60% DA170, | NT28 No- | | | | | |
| 40% DA176 | Tox Paper/ | | | | | |
| | Posterboard | | | | | |
| | Black Ink | | | | | |
| Nazdar DA Series | Colorcon | 3M SP7533 | 26.759 | Yes | No crack | No crack |
| 60% DA170, | NT28 No- | | | | | |
| 40% DA176 | Tox Paper/ | | | | | |
| | Posterboard | | | | | |
| | Red Ink | | | | | |

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention. All documents cited herein are in relevant part, incorporated by reference. The citation of any document is not to be construed as an admission that it is prior art with respect to the present invention.

What is claimed is:

1. A temporary decoration for application to fabric, the temporary decoration comprising:
a) a backing sheet;
b) a colorant wherein the colorant is an ink, a pigment, a dye, or a combination thereof;
c) an adhesive layer comprising a pressure sensitive adhesive; and
d) a release agent, wherein said release agent is included as a separate release layer, as part of the colorant, and combinations thereof;
e) optionally a protective layer made of polyurethane; and
f) optionally a release sheet; wherein the temporary decoration is applied without the need for heat or a solvent.

2. A temporary decoration for application to fabric, according to claim 1 wherein the backing sheet is selected from the group consisting of high density polyethylene, polystyrene, polypropylene, wax paper or a combination thereof.

3. The temporary decoration of claim 1 wherein the release agent comprises polyurethane.

4. The temporary decoration of claim 3 wherein the polyurethane is formed from the reaction of hexanedioic acid polymer with a catalyst.

5. The temporary decoration of claim 4 wherein the catalyst comprises toluene 2,6-diisocyanate.

6. The temporary decoration of claim 5 wherein the polyurethane is formed from the reaction of hexanedioic acid polymer with toluene 2,6-diisocyanate in a ratio of from about 75:1 to about 135:1.

7. The temporary decoration of claim 1 comprising a colorant layer comprising polyurethane.

8. The temporary decoration of claim 7 wherein the polyurethane in the colorant layer is formed from the reaction of hexanedioic acid polymer with toluene 2,6-diisocyanate in a ratio of from about 75:1 to about 135:1.

9. The temporary decoration of claim 7 wherein the colorant further comprises a viscosity reducer.

10. The temporary decoration of claim 1 wherein the pressure sensitive adhesive comprises acrylic polymers or acrylic copolymers.

11. A method of making a temporary decoration, the method comprising the steps of:
a) providing a screen;
b) placing a backing sheet under the screen;
c) applying a release agent to the screen such that the release agent contacts the backing sheet;
d) applying a colorant to the screen such that the colorant contacts the release agent; and
e) applying a pressure sensitive adhesive to the screen such that the pressure sensitive adhesive contacts the colorant.

12. A method of making a temporary decoration, the method comprising the steps of:
a) providing a backing sheet;
b) applying a release agent to the top of the backing sheet;
c) utilizing an applicator rod to apply the release agent in the y-axis direction of the backing sheet so as to form a layer of uniform thickness of the release agent on the backing sheet;
d) drying the backing sheet with the release agent applied thereto;
e) applying a protective layer
f) utilizing the applicator rod to apply the protective layer in the y-axis direction of the backing sheet so as to form a layer of uniform thickness of the protective layer on the release layer;
g) applying a colorant to the top of the backing sheet;
h) utilizing the applicator rod to apply the colorant in the y-axis direction of the backing sheet so as to form a layer of uniform thickness of the colorant on the protective layer;
i) drying the backing sheet with the release layer, the protective layer, and colorant applied thereto;
j) applying a pressure sensitive adhesive to the top of the backing sheet;
k) utilizing the applicator rod to apply the pressure sensitive adhesive in the y-axis direction of the backing sheet so as to form a layer of uniform thickness of the pressure sensitive adhesive on the colorant;
l) drying the backing sheet with the release agent, protective layer, colorant, and adhesive applied thereto;
m) applying a release sheet to the backing sheet with the release agent, protective layer, colorant, and adhesive applied thereto; and
n) using a laser to cut into the shape of a desired pattern.

13. A method of applying a temporary decoration to fabric, the method comprising the steps of:
a) providing a temporary decoration comprising a backing sheet which includes a release agent, an optional protective layer, a colorant comprising a design, an adhesive layer, and a release sheet;
b) removing the release sheet;
c) applying the temporary decoration to a fabric by contacting the adhesive layer of the temporary decoration to the fabric; and
d) applying an effective amount of force across the temporary decoration so as to transfer the design-containing portion of the temporary decoration to the fabric.

14. The method of claim 13 wherein the force required to transfer the design-containing portion of the temporary decoration to the fabric is from about 5 Newtons/cm² to about 25 Newtons/cm².

15. The method of claim 13 wherein the effective amount of force is applied to the temporary decoration by an implement selected from the group consisting of the finger nail of a person applying the decoration, coin, popsicle stick, and other rubbing implement and combinations thereof.

16. A temporary decoration for fabric, the temporary decoration comprising a design-containing portion and a backing portion, wherein the force required to separate the design-containing portion of the temporary decoration from the backing portion of the temporary decoration is from about 0.01 Newtons to about 0.33 Newtons as measured by the 90° Peel Method and wherein the design-containing portion exhibits no cracking using a cylinder having less than or equal to a 0.75 inch diameter as measured by the Mandrel Bend Test.

17. A temporary decoration for fabric according to claim 16 wherein upon application of a force from about 0.01 Newtons to about 0.33 Newtons as measured by the 90° Peel Method there results a visual cue to a user of successful separation of the design containing portion of the temporary decoration from the backing portion of the temporary decoration, said visual cue consisting of a change in the intensity of the color of the design as viewed through the backing portion.

18. A temporary decoration for fabric, the temporary decoration comprising a design-containing portion and a backing portion, wherein the force required to separate the design-containing portion of the temporary decoration from the backing portion of the temporary decoration is from about 0.01 Newtons to about 0.33 Newtons as measured by the 90° Peel Method and wherein the differential between the stiffness of the fabric with the design-containing portion applied thereto and the stiffness of the fabric without the design-containing portion applied thereto is from about 0 grams to about 90 grams as measured by the Stiffness Measurement-Blade/Slot Method.

19. A temporary decoration for fabric according to claim 18 wherein upon application of a force from about 0.01 Newtons to about 0.33 Newtons as measured by the 90° Peel Method there results a visual cue to a user of successful separation of the design containing portion of the temporary decoration from the backing portion of the temporary decoration, said visual cue consisting of a change in the intensity of the color of the design as viewed through the backing portion.

20. A temporary decoration for fabric, comprising a design-containing portion and a backing portion, wherein the force required to separate the design-containing portion of the temporary decoration from the backing portion of the temporary decoration is from about 0.01 Newtons to about 0.33 Newtons as measured by the 90° Peel Method and wherein the differential between the stiffness of the fabric with the design-containing portion applied thereto and the stiffness of the fabric without the design-containing portion applied thereto is from about 0 grams to about 90 grams as measured by the Stiffness Measurement-Blade/Slot Method and wherein the design-containing portion exhibits no cracking using a cylinder having less than or equal to a 0.75 inch diameter as measured by the Mandrel Bend Test.

21. A temporary decoration for fabric according to claim 20 wherein upon application of a force from about 0.01 Newtons to about 0.33 Newtons as measured by the 90° Peel Method there results a visual cue to a user of successful separation of the design containing portion of the temporary decoration from the backing portion of the temporary decoration, said visual cue consisting of a change in the intensity of the color of the design as viewed through the backing portion.

22. A method of removing a temporary decoration from fabric, the method comprising the steps of:
a) providing a fabric with a design-containing portion of a temporary decoration applied thereto; and
b) contacting the design-containing portion of the temporary decoration with water so as to remove the temporary decoration from the fabric.

23. A method of removing a temporary decoration from fabric according to claim 22 additionally comprising the step of contacting the design-containing portion of the temporary decoration with a removal implement so as to remove the design-containing portion of the temporary decoration from the fabric.

24. The method of claim 23 wherein the removal implement is a pad.

25. The method of claim 24 wherein the pad includes a textured side, wherein the textured side contacts the design-containing portion of the temporary decoration.

26. A temporary decoration kit, the temporary decoration kit comprising:
a) a temporary decoration comprising a design-containing portion for application to fabric; and
b) a removal implement for removing the design-containing portion of the temporary decoration from a fabric.

27. The temporary decoration kit of claim 26 further comprising instructions for applying the design-containing portion of the temporary decoration to fabric and removing the design-containing portion of the temporary decoration from the fabric.
